(19) United States
(12) Patent Application Publication
(10) Pub. No.: US 2020/0065123 A1
(43) Pub. Date: Feb. 27, 2020

(54) SIMULATION OF INTERNET OF THINGS SYSTEMS

(71) Applicant: Intel Corporation, Santa Clara, CA (US)

(72) Inventors: Shao-Wen Yang, San Jose, CA (US); Nyuk Kin Koo, Bukit Mertajam (MY); Yen-Kuang Chen, Palo Alto, CA (US)

(73) Assignee: Intel Corporation, Santa Clara, CA (US)

(21) Appl. No.: 16/466,597

(22) PCT Filed: Jan. 4, 2017
(86) PCT No.: PCT/US2017/012071

§ 371 Date: Jun. 4, 2019

(51) Int. Cl. G06F 9/455

(52) U.S. Cl. CPC G06F 9/455; G06F 8/60

(57) ABSTRACT

A simulation is defined to include a particular test environment and one or more device models, where each device model simulates a respective device, the test environment simulates a physical environment, and the one or more device models are populated in the IoT testing environment to model a deployment of devices corresponding to the device models in the physical environment. Modeled device data is generated, based on the one or more device models, to simulate data generated by corresponding devices. The modeled device data is transmitted to an application, and application data is received in response from the application and used in the simulation.

### TECHNICAL FIELD

This disclosure relates in general to the field of computer systems and, more particularly, to managing machine-to-machine systems.

### BACKGROUND

The Internet has enabled interconnection of different computer networks all over the world. While previously, Internet-connectivity was limited to conventional general purpose computing systems, ever increasing numbers and types of products are being redesigned to accommodate connectivity with other devices over computer networks, including the Internet. For example, smart phones, tablet computers, wearables, and other mobile computing devices have become very popular, even supplanting larger, more traditional general purpose computing devices, such as traditional desktop computers in recent years. Increasingly, tasks traditionally performed on a general purpose computers are performed using mobile computing devices with smaller form factors and more constrained features sets and operating systems. Further, traditional appliances and devices are becoming “smarter” as they are ubiquitous and equipped with functionality to connect to or consume content from the Internet. For instance, devices, such as televisions, gaming systems, household appliances, thermostats, automobiles, watches, have been outfitted with network adapters to allow the devices to connect with the Internet (or another device) either directly or through a connection with another computer connected to the network. Additionally, this increasing universe of interconnected devices has also facilitated an increase in computer-controlled sensors that are likewise interconnected and collecting new and large sets of data. The interconnection of an increasingly large number of devices, or “things,” is believed to foreshadow an era of advanced automation and interconnectivity, referred to, sometimes, as the Internet of Things (IoT).

### BRIEF DESCRIPTION OF THE DRAWINGS

FIG. 1A illustrates an embodiment of a system including multiple sensor devices and an example management system.

FIG. 1B illustrates an embodiment of a cloud computing network.

FIG. 1C illustrates a block diagram of an embodiment of an IoT device.

FIG. 2 illustrates an embodiment of a system including an example management system.

FIG. 3 is a simplified diagram illustrating a graphical user interface (GUI) providing an example library of IoT testing environments.

FIG. 4 is a simplified diagram illustrating a GUI providing an example library of IoT testing devices, IoT testing sensors, and IoT testing actuators.

FIG. 5 is a flowchart illustrating an example technique for generating IoT testing models to enable detection of semantic errors in real-world IoT systems.

FIGS. 6A-6H are simplified diagrams providing one example of a GUI for generating IoT testing models to enable detection of semantic errors in IoT systems.

FIG. 7 is a block diagram of an exemplary processor in accordance with one embodiment; and

FIG. 8 is a block diagram of an exemplary computing system in accordance with one embodiment.

Like reference numbers and designations in the various drawings indicate like elements.

### DETAILED DESCRIPTION

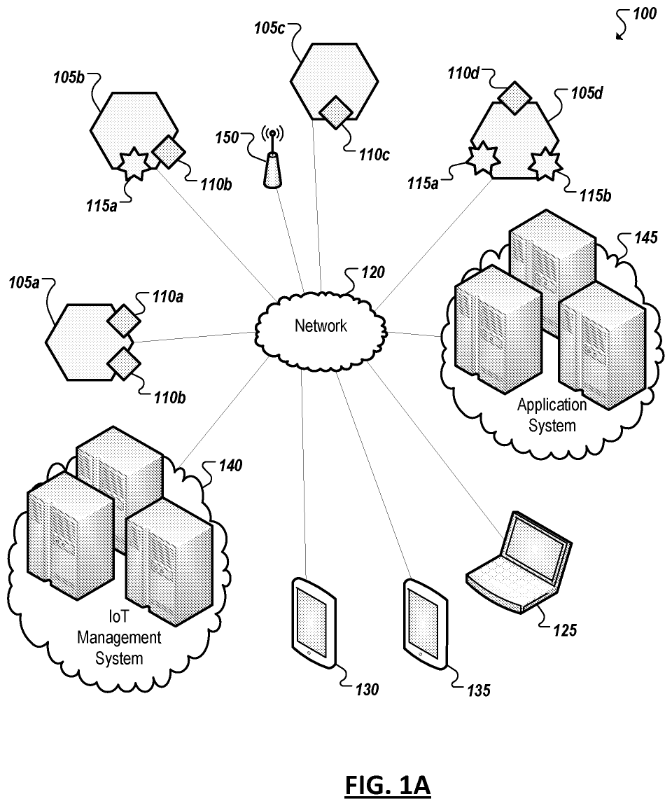

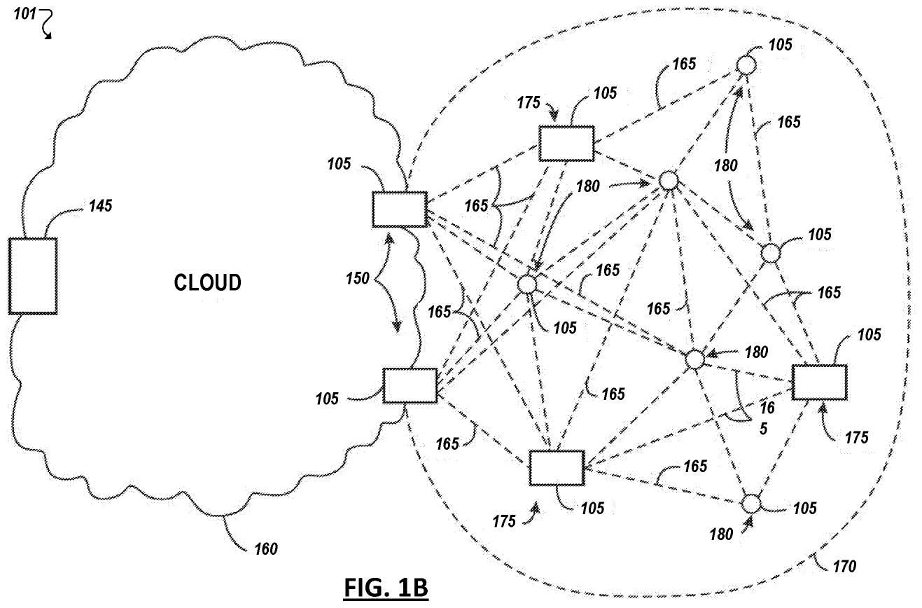

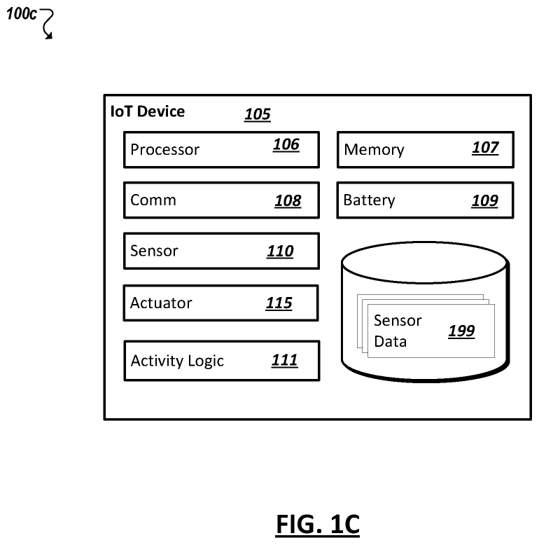

FIG. 1A is a block diagram illustrating a simplified representation of a real-world IoT system (e.g., 100) that includes one or more IoT devices (e.g., 105a-105d), deployed throughout a real-world environment (e.g., a house, a school, a commercial building a government building, room, etc.). Each IoT device 105a-105d may include a computer processor and/or communications module to allow each IoT device 105a-105d to interoperate with one or more other IoT devices (e.g., 105a-105d) or systems in the environment. Each IoT device 105 can further include one or more IoT assets, including instances of various types of sensors (e.g., 110a-110d), actuators (e.g., 115a-115b), storage, power, computer processing, and communication assets that can be leveraged and utilized (e.g., by other devices or software) within a machine-to-machine, or IoT system or application. In some cases, inter-device communication and even deployment of an IoT system may be facilitated by one or more gateway devices (e.g., 150) through which one or more of the IoT devices (e.g., 105a-105d) communicate and gain access to other devices and systems via one or more networks (e.g., 120).

Sensors 110a-110d, or sensor assets, are capable of detecting, measuring, and generating sensor data (e.g., 199) representing characteristics of the real-world environment in which they reside, are mounted, or are in contact. For instance, a given sensor (e.g., 110a-110d) may be configured to detect one or more respective characteristics such as movement, weight, physical contact, temperature, wind, noise, light, computer communications, wireless signals, position, humidity, the presence of radiation, liquid, specific chemicals, or chemical compounds, among several other examples. Indeed, sensors (e.g., 110a-110d) as described herein, anticipate the development of a potentially limitless universe of various sensors, each designed to, and capable of, detecting and generating corresponding sensor data (e.g., 199) for new and known environmental characteristics. Actuator assets (e.g., 115a-115b) can allow an IoT device (e.g., 105) to perform some kind of action to affect its associated real-world environment. For instance, one or more of the IoT devices (e.g., 105) may include one or more respective actuators (e.g., 115) that accepts an input and perform its respective action in response thereto. Actuators (e.g., 115) can include controllers to activate additional functionality, such as an actuator to selectively toggle the power or operation of an alarm, camera (or other sensors), heating, ventilation, and air conditioning (HVAC) appliance, household appliance, in-vehicle device, lighting, among other examples.

In some implementations, sensors 110a-110d and actuators 115a-115b provided on devices 105a-105d can be assets incorporated in and/or forming an IoT or machine-to-machine (M2M) system. IoT systems can refer to new or improved ad-hoc systems and networks composed of multiple different devices interoperating and synergizing to deliver one or more results or deliverables. Such ad-hoc systems are emerging as more and more products and equipment evolve to become “smart” in that they are controlled or monitored by computing processors and provided with facilities to communicate, through computer-implemented mechanisms, with other computing devices (and products having network communication capabilities). For instance, IoT systems can include networks built from sensors and communication modules integrated in or attached to “things” such as equipment, toys, tools, vehicles, etc. and even living things (e.g., plants, animals, humans, etc.). In some instances, an IoT system can develop organically or unexpectedly, with a collection of sensors monitoring a variety of things and related environments and interconnecting with data analytics systems and/or systems controlling one or more other smart devices to enable various use cases and application, including previously unknown use cases. Further, IoT systems can be formed from devices that hitherto had no contact with each other, with the system being composed and automatically configured spontaneously or on the fly (e.g., in accordance with an IoT application defining or controlling the interactions). Further, IoT systems can often be composed of a complex and diverse collection of connected IoT devices (e.g., 105a-105d), such as devices sourced or controlled by varied groups of entities and employing varied hardware, operating systems, software applications, and technologies. In some cases, a gateway (e.g., 150) may be provided to localize a particular IoT system, with the gateway 150 able to detect nearby devices (e.g., 105a-105d) and deploy (e.g., in an automated, impromptu manner) an instance of a particular IoT application by orchestrating configuration of these detected devices to satisfy requirements of the particular IoT application, among other examples.

Facilitating the successful interoperability of such diverse systems is, among other example considerations, an important issue when building or defining an IoT system. Software applications can be developed to govern how a collection of IoT devices can interact to achieve a particular goal or service. In some cases, the IoT devices may not have been originally built or intended to participate in such a service or in cooperation with one or more other types of IoT devices. Indeed, part of the promise of the Internet of Things is that innovators in many fields will dream up new applications involving diverse groupings of the IoT devices as such devices become more commonplace and new “smart” or “connected” devices emerge. However, the act of programming, or coding, such IoT applications may be unfamiliar to many of these potential innovators, thereby limiting the ability of these new applications to be developed and come to market, among other examples and issues.

As shown in the example of FIG. 1A, multiple IoT devices (e.g., 105a-105d) can be provided from which one or more different IoT application deployments can be built. For instance, a IoT device (e.g., 105a-105d) can include such examples as a mobile personal computing device, such as a smart phone or tablet device, a wearable computing device (e.g., a smart watch, smart garment, smart glasses, smart helmet, headset, etc.), purpose-built devices such as and less conventional computer-enhanced products such as home, building, vehicle automation devices (e.g., smart heat-ventilation-air-conditioning (HVAC) controllers and sensors, light detection and controls, energy management tools, etc.), smart appliances (e.g., smart televisions, smart refrigerators, etc.), and other examples. Some devices can be purpose-built to host sensor and/or actuator resources, such as a climate sensor device that includes multiple sensors related to climate monitoring (e.g., temperature, wind, humidity sensors, etc.), traffic sensors and controllers, among many other examples. Some IoT devices (e.g., 105a-105d) may be statically located, such as a device mounted within a building, on a lamppost, sign, water tower, secured to a floor (e.g., indoor or outdoor), or other fixed or static structure. Other devices may be mobile, such as a sensor provisioned in the interior or exterior of a vehicle, in-package sensors (e.g., for tracking cargo), wearable devices worn by active human or animal users, an aerial, ground-based, or underwater drone among other examples. Indeed, it may be desired that some sensors move within an environment and applications can be built around use cases involving a moving subject or changing environment using such devices, including use cases involving both moving and static devices, among other examples.

Continuing with the example of FIG. 1A, software-based IoT management platforms can be provided to allow developers and end users to build and configure IoT applications and systems. Further, an IoT application can provide software support to organize and manage the operation of a set of IoT devices for a particular purpose or use case. In some cases, an IoT application can be embodied as an application on an operating system of a user computing device (e.g., 125), a mobile app for execution on a smart phone, tablet, smart watch, or other mobile device (e.g., 130, 135), a remote server, and/or gateway device (e.g., 150). In some cases, the application can have or make use of an application management utility allowing users to configure settings and policies to govern how the set IoT devices (e.g., 105a-105d) are to operate within the context of the application. A management utility can also be used to orchestrate the deployment of a particular instance of an IoT application, including the automated selection and configuration of devices (and their assets) that are to be used with the application. In some cases, an IoT management platform can include IoT deployment testing or simulation tools, such as discussed herein.

In some cases, an IoT management application may be provided (e.g., on a gateway, user device, or cloud-based server, etc.), which can manage potentially multiple different IoT applications or systems. For instance, an IoT management application, or system, may be hosted on a single system, such as a single server system (e.g., 140), a single end-user device (e.g., 125, 130, 135), or a single gateway device (e.g., 150), among other examples. Alternatively, an IoT management system, or other system, may be implemented to be distributed across multiple hosting devices (e.g., 125, 130, 135, 140, 150, etc.).

As noted above, IoT applications may be localized, such that a service is implemented utilizing an IoT system (e.g., of devices 105a-105d) within a specific geographic area, room, or location. In some instances, IoT devices (e.g., 105a-105d) may connect to one or more gateway devices (e.g., 150) on which a portion of management functionality (e.g., as shared with or supported by management system 140) and a portion of application service functionality (e.g., as shared with or supported by application system 145) is shared. Service logic and configuration data may be pushed (or pulled) to the gateway device 150 and used to configure IoT devices (e.g., 105a-105d, 130, 135, etc.) within range or proximity of the gateway device 150 to allow the set of devices to implement a particular service within that location. A gateway device (e.g., 150) may be implemented as a dedicated gateway element, or may be a multi-purpose or general purpose device, such as another IoT device (similar to devices 105a-105d) or user device (e.g., 125, 130, 135) that itself may include sensors and/or actuators to perform tasks within an IoT system, among other examples.

In some cases, IoT systems can interface (through a corresponding IoT management system or application or one or more of the participating IoT devices) with remote services, such as data storage, information services (e.g., media services, weather services), geolocation services, and computational services (e.g., data analytics, search, diagnostics, etc.) hosted in cloud-based and other remote systems (e.g., 140, 145). For instance, the IoT system (e.g., 100) can connect (e.g., directly or through a gateway 150) to a remote service or application (e.g., 145) over one or more networks 120. In some cases, the remote service can, itself, be considered an asset of an IoT application. Data received by a remotely-hosted service can be consumed by the governing IoT application and/or one or more of the component IoT devices to cause one or more results or actions to be performed, among other examples. The one or more networks (e.g., 120) can facilitate communication between sensor devices (e.g., 105a-105d), end user devices (e.g., 123, 130, 135), gateways (e.g., 150), and other systems (e.g., 140, 145) utilized to implement and manage IoT applications in an environment. Such networks can include wired and/or wireless local networks, public networks, wide area networks, broadband cellular networks, the Internet, and the like.

In one example, an application server 145 may include one or more data processing apparatus, one or more memory elements, and one or more communication modules incorporating hardware and logic to allow the application server 145 to communicate over one or more networks (e.g., 120). The application server 145 may further run an operating system and one or more applications. The applications may consume and/or generate various data hosted at the application server 145 (or other data stores). The applications may, in some cases, include service logic utilized during runtime and/or deployment of an IoT system (e.g., including devices 105a-105d) or may be services, which are consumed by elements of the service logic utilized in an IoT system deployment (e.g., and hosted on devices (e.g., 105a-105d), user device 130, or other machines associated with an IoT system's deployment. An application, in one example, may receive data generated by one or more sensor assets (e.g., 110d) of one or more devices (e.g., 105d) deployed in an IoT system (e.g., 100) and apply logic embodied in one or more applications to generate results, which may be presented in a report or graphical user interface (GUI) of a user device (e.g., 130). Such results may even be returned to one or more of the participating devices (e.g., 105) for consumption by the deployed device (e.g., in connection with the triggering of an actuator asset (e.g., 115a) of the device (e.g., 105b)) during runtime of the IoT system, among other, potentially limitless examples.

User devices (e.g., 125, 130, 135) may be utilized in a variety of ways within an IoT application deployment. Each user device (e.g., 125, 130, 135) may possess management system functionality, functionality of an IoT service development system, may be utilized to control or manage a particular IoT application (e.g., through a UI of the IoT application provided on the device 130), or to provide other assets (e.g., sensor, actuator, computing, or storage) for use in a particular IoT application deployment. In one example, a user device 130 may include a UI engine, which may be leveraged in a particular IoT application deployment to provide one or more UIs for use by a user in connection with the deployment. A user device (e.g., 125, 130, 135) may include one or more data processors, one or more memory elements, a communication module enabling communication with other systems using wireless and/or wireline network connections, and an operating system on which one or more applications may be run. A user device (e.g., 125, 130, 135) may include one or more input devices, which may embody sensors implementing a touchscreen interface, keyboard, tracker ball, camera, or other mechanism through which user inputs may be captured. A user device (e.g., 125, 130, 135) may also include one or more presentation devices (e.g., driven by corresponding actuators) to implement a graphical display, an audio presentation (e.g., speakers), a light output (e.g., of an integrated LED flashlight or camera flash), or vibration motor to output vibration-based signals, among other examples. Input devices and presentation devices, and computing resources of a user device (e.g., 130) may be utilized to fulfill UI requirements of a particular IoT application, resulting in the deployment of a user device (e.g., 125, 130, 135) in connection with deployment of the particular IoT application, among other example uses.

In general, “servers,” “clients,” “computing devices,” “network elements,” “hosts,” “system-type system entities,” “user devices,” “gateways,” “IoT devices,” “sensor devices,” and “systems” (e.g., 105a-105d, 125, 130, 135, 140, 145, 150, etc.) in example real-world computing environment 100, can include electronic computing devices operable to receive, transmit, process, store, or manage data and information associated with the real-world computing environment 100. As used in this document, the term “computer,” “processor,” “processor device,” or “processing device” is intended to encompass any suitable processing apparatus. For example, elements shown as single devices within the real-world computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

While FIG. 1A is described as containing or being associated with a plurality of elements, not all elements illustrated within real-world computing environment 100 of FIG. 1A may be utilized in each alternative implementation of the present disclosure. Additionally, one or more of the elements described in connection with the examples of FIG. 1A may be located external to computing environment 100, while in other instances, certain elements may be included within or as a portion of one or more of the other described elements, as well as other elements not described in the illustrated implementation. Further, certain elements illustrated in FIG. 1A may be combined with other components, as well as used for alternative or additional purposes in addition to those purposes described herein.

As noted above, a collection of devices, or endpoints, may participate in IoT networking, which may utilize wireless local area networks (WLAN), such as those standardized under IEEE 802.11 family of standards, home-area networks such as those standardized under the Zigbee Alliance, personal-area networks such as those standardized by the Bluetooth Special Interest Group, cellular data networks, such as those standardized by the Third-Generation Partnership Project (3GPP), and other types of networks, having wireless, or wired, connectivity. For example, an endpoint device may also achieve connectivity to a secure domain through a bus interface, such as a universal serial bus (USB)-type connection, a High-Definition Multimedia Interface (HDMI), or the like.

As shown in the simplified block diagram of FIG. 1B, in some instances, a cloud computing network, or cloud, in communication with a mesh network 101 of IoT devices (e.g., 105a-105d), which may be termed a “fog,” may be operating at the edge of the cloud. To simplify the diagram, not every IoT device 105 is labeled.

The fog 170 may be considered to be a massively interconnected network wherein a number of IoT devices 105 are in communications with each other, for example, by radio links 165. This may be performed using the open interconnect consortium (OIC) standard specification 1.0 released by the Open Connectivity Foundation™ (OCF) on Dec. 23, 2015. This standard allows devices to discover each other and establish communications for interconnects. Other interconnection protocols may also be used, including, for example, the optimized link state routing (OLSR) Protocol, or the better approach to mobile ad-hoc networking (B.A.T.M.A.N.), among others.

Three types of IoT devices 105 are shown in this example, gateways 150, data aggregators 175, and sensors 180, although any combinations of IoT devices 105 and functionality may be used. The gateways 150 may be edge devices that provide communications between the cloud 160 and the fog 170, and may also function as charging and locating devices for the sensors 180. The data aggregators 175 may provide charging for sensors 180 and may also locate the sensors 180. The locations, charging alerts, battery alerts, and other data, or both may be passed along to the cloud 160 through the gateways 150. As described herein, the sensors 180 may provide power, location services, or both to other devices or items.

Communications from any IoT device 105 may be passed along the most convenient path between any of the IoT devices 105 to reach the gateways 150. In these networks, the number of interconnections provide substantial redundancy, allowing communications to be maintained, even with the loss of a number of IoT devices 105.

The fog 170 of these IoT devices 105 devices may be presented to devices in the cloud 160, such as a server 145, as a single device located at the edge of the cloud 160, e.g., a fog 170 device. In this example, the alerts coming from the fog 170 device may be sent without being identified as coming from a specific IoT device 105 within the fog 170. For example, an alert may indicate that a sensor 180 needs to be returned for charging and the location of the sensor 180, without identifying any specific data aggregator 175 that sent the alert.

In some examples, the IoT devices 105 may be configured using an imperative programming style, e.g., with each IoT device 105 having a specific function. However, the IoT devices 105 forming the fog 170 may be configured in a declarative programming style, allowing the IoT devices 105 to reconfigure their operations and determine needed resources in response to conditions, queries, and device failures. Corresponding service logic may be provided to dictate how devices may be configured to generate ad hoc assemblies of devices, including assemblies of devices which function logically as a single device, among other examples. For example, a query from a user located at a server 145 about the location of a sensor 180 may result in the fog 170 device selecting the IoT devices 105, such as particular data aggregators 175, needed to answer the query. If the sensors 180 are providing power to a device, sensors associated with the sensor 180, such as power demand, temperature, and the like, may be used in concert with sensors on the device, or other devices, to answer a query. In this example, IoT devices 105 in the fog 170 may select the sensors on particular sensor 180 based on the query, such as adding data from power sensors or temperature sensors. Further, if some of the IoT devices 105 are not operational, for example, if a data aggregator 175 has failed, other IoT devices 105 in the fog 170 device may provide substitute, allowing locations to be determined.

Further, the fog 170 may divide itself into smaller units based on the relative physical locations of the sensors 180 and data aggregators 175. In this example, the communications for a sensor 180 that has been instantiated in one portion of the fog 170 may be passed along to IoT devices 105 along the path of movement of the sensor 180. Further, if the sensor 180 is moved from one location to another location that is in a different region of the fog 170, different data aggregators 175 may be identified as charging stations for the sensor 180.

As an example, if a sensor 180 is used to power a portable device in a chemical plant, such as a personal hydrocarbon detector, the device will be moved from an initial location, such as a stockroom or control room, to locations in the chemical plant, which may be a few hundred feet to several thousands of feet from the initial location. If the entire facility is included in a single fog 170 charging structure, as the device moves, data may be exchanged between data aggregators 175 that includes the alert and location functions for the sensor 180, e.g., the instantiation information for the sensor 180. Thus, if a battery alert for the sensor 180 indicates that it needs to be charged, the fog 170 may indicate a closest data aggregator 175 that has a fully charged sensor 180 ready for exchange with the sensor 180 in the portable device.

Deployment of devices 105a-105d in a system (e.g., 100 and 101) can involve automatically or manually initiating one or more sensors (e.g., 110) and/or actuators (e.g., 115) to participate in a new or ongoing IoT application deployment. FIG. 1C illustrates an example IoT device (e.g., 105), deployments of which are illustrated in IoT systems 100 and 101. That is, while IoT systems 100 and 101 illustrate a particular number of IoT devices 105, various other IoT systems may include other quantities of IoT devices 105 provided there is at least one IoT device 105 within the IoT system.

IoT device 105 may include one or more data processing apparatus (or “processors”) (e.g., 106), one or more memory elements (e.g., 107), one or more communications modules (e.g., 108), a battery (e.g., 109) or other power source (e.g., a solar cell, etc.), among other components. IoT device 105 can possess hardware, software, firmware, one or more sensors (e.g., 110), one or more actuators (e.g., 115), and other logic (e.g., 111), among other devices and/or code, to realize the intended function(s) of the IoT device 105 (including operation of the respective sensors and actuators). In some cases, IoT device 105 may be provided with such assets as one or more sensors (e.g., 110) of the same or varying types, actuators (e.g., 115) of varying types, computing assets (e.g., through a respective processor and/or software logic), security features, data storage assets, and other resources. The sensor(s) can generate sensor data (e.g., 199) representing the representing characteristics of the real-world environment in which they reside, are mounted, or are in contact.

Communication modules (e.g., 108) can be utilized as a communication asset within some deployments of IoT device 105. The communication module (e.g. 108) may include hardware and software to facilitate communication over one or more networks (e.g., 120), utilizing one or more technologies (e.g., WiFi, Bluetooth, Near Field Communications, Zigbee, Ethernet, etc.), with other systems and devices.

With the emergence of IoT systems (e.g., 100, 101), it is anticipated that over fifty billion devices will be available to be interconnected by the year 2020, potentially enabling enormous and world-changing opportunities in terms of technology breakthrough and business development. For instance, in home automation systems, automation of a home is typically increased as more IoT devices are added for use in sensing and controlling additional aspects of the home. However, as the number and variety of devices increase, the management of “things” (or devices for inclusion in IoT systems) becomes outstandingly complex and challenging.

When testing Internet of Things (IoT) systems, devices, and applications, syntax errors can be determined relatively easily. On the other hand, semantic errors can be and usually are more difficult to detect than syntax errors. For example, an IoT system, IoT device, or IoT application may be coded correctly, but may not generate or produce the correct outputs or results. In other words, an IoT system, IoT device, or IoT application may include difficult-to-detect operational errors and/or output errors (i.e., semantic errors), even though the IoT system, IoT device, or IoT application is void of syntax errors.

Accordingly, one of the obstacles preventing the adoption of IoT systems is the difficulty in detecting semantic errors during development and/or deployment of IoT systems, which may be based on the example issues including the following (among others):
Some systems use incorrect sensors and/or actuators. Prior deployment, IoT devices are only known by their digital identifiers (e.g., MAX addresses, IP addresses, etc.);
Devices may include conflicting parameters. For example, a power-saving device may be attempting to turn lights OFF simultaneously with a smart lighting device trying to turn the lights ON;
Validation of an IoT system is subjective, as a whole. User intention defines the functionality of an IoT system, which can change over time or from user to user; and
User limitations. IoT devices 105 (and sensors 110 and/or actuators 115) are often spread out spatially across an environment with intermittently temporally triggered events, which magnifies the complexity of the debugging process for a human, as a practical matter.

Such issues may contribute to the difficulty in detecting semantic errors, which are addressed by the various examples and implementations discussed herein. In IoT systems deploying multiple heterogeneous IoT devices and varied combinations of IoT sensors, actuators, and other IoT assets, reliably detecting semantic errors that occur in an IoT system and, in particular, a customized IoT system (e.g., an IoT system deployed for a specific building or floor within a building) where the combination and use of IoT devices in the deployment may be particularly tailored to a specific floorplan, user preferences, custom IoT application, etc. may be particularly difficult. In these type of IoT systems, it may be desirable to generate an IoT testing environment that is custom-tailored (e.g., modeled) with IoT testing devices, IoT testing sensors, and/or testing actuators deployed in specific locations within the IoT testing environment that correspond to the specific locations of the IoT devices, IoT sensors, and/or actuators deployed in the corresponding real-world environment.

Additionally, semantic errors may manifest themselves in a variety of forms. Indeed, the diversity of potential semantic errors appearing in a particular IoT system or a particular IoT device 105 may make it difficult or impossible to fully comprehend the potential array of semantic errors. For example, in the context of semantic error detection, there may be semantic errors in which detection is constrained by the limitations of the user to access the IoT assets (e.g., distance-based, angle-based, distribution-based, and principal component analysis (PCA)-based semantic errors, among other examples). Utilizing an IoT testing model implementing an IoT testing environment can, as a practical matter, simplify detecting semantic errors attributed to at least some user limitations.

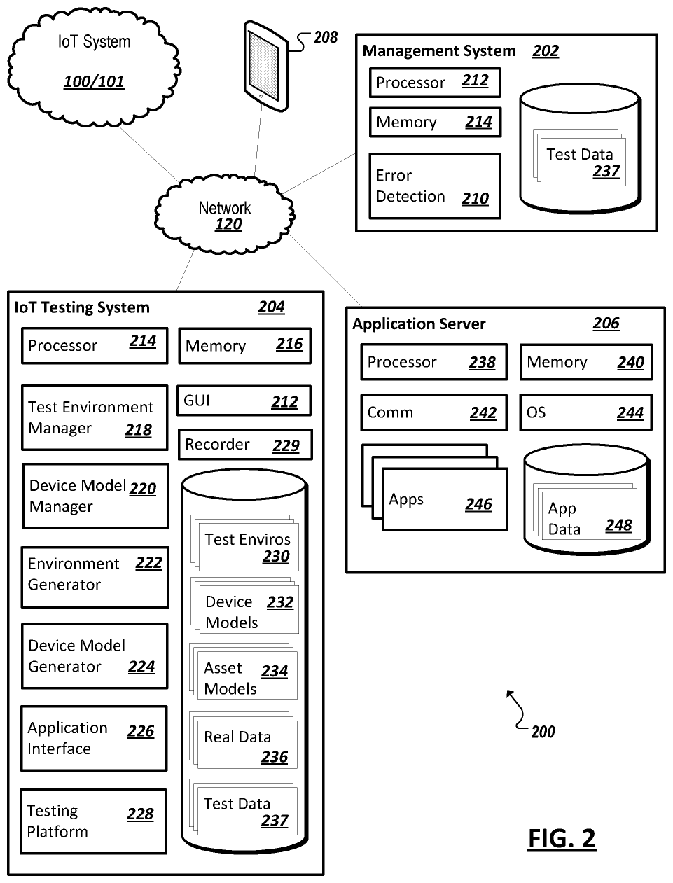

Systems, such as those shown and illustrated herein, can include machine logic implemented in hardware, software, and/or firmware to implement the systems and solutions introduced herein and address at least some of the example issues related to detecting semantic errors in IoT systems (e.g., 100, 101), among other issues. For instance, FIG. 2 shows a simplified block diagram illustrating a system (e.g., 200) including a management system (e.g., 202), a testing management system (e.g., 204), an application server (e.g., 206), and a user device (e.g., 208) with functionality to simulate and test real or planned IoT system deployments (e.g., 100, 101) for semantic errors. An IoT system (e.g., 100, 101) being tested can include multiple IoT devices (e.g., 105) with composite IoT assets such as sensors (e.g., 110) and/or actuators (e.g., 115) capable of being used in a variety of different IoT applications, as discussed above with reference to FIGS. 1A-1C.

In the example of FIG. 2, a management system (e.g., 202) can be provided with error detection logic 210 (implemented in hardware and/or software) to detect semantic errors in IoT systems (e.g., 100, 101). For instance, user interfaces may be presented to allow users to observe modeled performance of an example IoT deployment and observe semantic abnormalities and errors in the deployment. The management system 202, in some examples, may additionally be coupled to real world deployments (e.g., 100/101) to allow the real world deployments to be modeled and observed (and, thereby, potentially improved by observing opportunities to optimize configurations of the real deployment). In further examples, error detection logic 210 may be provided in an example testing management system to allow semantic error(s) to be detected from test data (e.g., 212) generated in simulations of an example IoT deployment, among other examples.

An IoT testing management system 204, at least in the example illustrated in FIG. 2, may include one or more data processing apparatus (e.g., 214) and one or more memory elements (e.g., 216) with code (implemented in hardware, firmware, and/or software) executable by the data processing apparatus 214 to implement a test environment manager (e.g., 218), a device model manager (e.g., 220), a test environment generator (e.g., 222), a device model generator (e.g., 224), an IoT application interface (e.g., 226), and an IoT testing platform (e.g., 228), among other example modules and logic. An example IoT testing environment manager 218 may be provided with functionality to enable an IoT testing environment (e.g., 230) to be launched within an IoT system simulation, or test, implemented using testing platform 228. The IoT testing environment may be a model generated or selected from a library or catalog of IoT testing environment models for use in simulations of various IoT systems (e.g., enable users to test for semantic errors in a real or hypothetical IoT system (e.g., 100, 101)). Each IoT testing environment model 230 may corresponds to and model a real-world environment (e.g., a building, a floor in a building, an outdoor location (e.g., agricultural area, border, etc.) in which an example IoT system may be deployed. Indeed, data may be collected from a real world deployment and the data may be parsed to determine a corresponding IoT testing environment model 230. Indeed, in some implementations, an IoT system (e.g., 204) may interface with or be integrated with a management system (e.g., 202) or other elements of a real-world deployment. In some implementations, an environment model 230 may define dimensionality of the environment (e.g., such that physical distances and/or proximity may be modeled), model physical features of the environment (e.g., obstructions impeding network communications, environmental features (e.g., temperatures, wind, moisture, etc.)) among other information. Each environmental model 230 may serve as a virtual representation of a corresponding real-world environment.

In one example, an IoT testing environment generator (e.g., 222) may be provided with functionality to generate/create or modify IoT testing environment models 230, each of which can be stored thereafter in the library or catalog of IoT testing environment models. Each IoT testing environment model 230 may be generated (or updated) in response to user inputs (e.g., manually generated), automatically generated by a computing device (e.g., IoT testing management system 204) based on predetermined dimensions or blueprints (e.g., CAD or other files parsable to determine attributes of a corresponding physical environment), or a combination of user inputs and computer generation. Further, graphical user interfaces (e.g., GUI 212) provided in connection with an IoT deployment simulation may utilize the environment models to generate a corresponding graphical representation of the corresponding physical environment for presentation to a user in connection with the simulation.

An example IoT device model manager 220 may be provided with functionality to enable one or more IoT device models (e.g., 232) to be selected from a library or catalog of device models to populate an IoT testing environment model (e.g., 230) within an example simulation. Each device model 232, when populated within an environment model or otherwise deployed in a simulation, may contain parameters and behavioral definitions to simulate or model a corresponding real-world IoT device (e.g., 105). Indeed, selection of a particular device model 232 for inclusion in a simulation causes the device model 232 to stand-in and represent its corresponding real-world IoT device. In some cases, this selection may be automated, for instance, by parsing data (e.g., an XML document or other file) describing the component devices in a real-world deployment and identifying a collection of device models (and corresponding parameters) that correspond to the real-world deployment. As IoT devices may be multi-modal, in that they include more than one IoT asset (e.g., sensors, actuators, compute resources, memory resources, communication resources, etc. for use in an IoT system), a corresponding device model (e.g., 232) may model each of the multiple assets of the device. In some instances, asset models (e.g., 234) may be defined to model particular IoT assets and a device model 232 can be considered a collection of the constituent asset models 234 corresponding to the modalities of the modeled device.

Each device or asset model may be configurable, such that parameters may be defined or modified to configure the precise modeled behavior offered by the respective device model 232 and/or asset model 234. For example, a sensor asset model may be configured to generate data of a particular type (e.g., particular units of measurement), according to a certain format (e.g., binary, packetized, analog, according to a particular communication protocol, etc.), with values within a particular range and according to a particular variability (e.g., random, cyclic, or steady values varying in value according to a noise model, frequency, etc.).

A device model generator (e.g., 224) may be provided with functionality to generate/create, modify, or configure one or more device models 232 and/or asset models 234, which can be stored thereafter in the library or catalog of models. In some cases, a device model 232 or asset model 234 may manually defined in a customized manner, with a user providing inputs to the IoT testing system 214 (e.g., through a GUI 212) to define various parameters of the model, select component asset models to be incorporated in the device model, etc., with the aim of defining a device model that accurately approximates the behavior of a corresponding real-world device. In other instances, generic device models 232 may be selected and used (based on user inputs). Still further, real data 236 describing real-world devices or real-world deployments (and related system configurations) may be obtained (e.g., from a system monitor or recording utility (e.g., 229) or other source (e.g., device documentation provided by a vendor or manufacturer providing the device, etc.), and the real data 236 may be parsed to identify attributes of one or more devices deployed or available in real-world systems 230. The real data 236 may thus be processed to select a device model template, component asset models, and/or configure parameter values based on the attributes of the device(s) described or discernable from the parsing of the real data, among other examples. In this manner, IoT systems (including very large-scale IoT deployments) may be emulated and tested (e.g., deployment scalability, fault handling, etc.) through a virtualized model of the deployment that is isolated from and cannot result in failures at the actual operating, live system. Results of the test may then be provided to a management system of the corresponding live system to allow optimizations and improvements determined through the test to be applied to the live system, among other examples.

An application interface 226 may be provided in some examples to identify one or more (real) IoT applications or services with which a given IoT deployment is to interact. The IoT application may be a management or gateway application to manage interoperation of the various IoT devices in the deployment, an application configured to consume data generated by the example IoT devices, and/or an application to provide directives or other results to at least some of the deployed devices to cause additional activities or changes to the IoT system deployment, among other examples. In a real-world deployment, the deployed devices may communicate with a host of the application(s) over a network (and in some cases over an IoT gateway). However, as the IoT deployments in simulations hosted by the IoT testing system 204 are (at least partially) virtual, an application interface 226 may be provided through which modeled outputs of the varied modeled IoT devices may be transmitted to the host (e.g., 206) of the application(s) (e.g., 246). The interface may be provided such that virtual nature of the simulated deployment (and devices) is hidden from the application (e.g., 246). Likewise, data generated by the application (e.g., 246) and transmitted for consumption by various simulated IoT devices may be handled by the application interface 226, such that communications between the application (e.g., 246) and any given device model (e.g., 232) may be handled and delivered for consumption by the corresponding device model. Further, through an example application interface 226, the one or more applications (e.g., 246) to be used in connection with a given simulated IoT deployment may be selected and invoked, among other example features and functionality.

A testing platform 228 may be provided, in some implementations, to orchestrate a simulation involving a selected environmental model 230, a collection of device models (e.g., 232), and one or more IoT applications (e.g., accessed via an application interface 226), among other examples. The testing platform 228 may invoke a simulation involving the selected device models 232 such that synthesized data is generated at each of the device models 232 and communicated within the deployment according to a deployment definition. In some cases, device models 232 may be configured to send the generated synthetic device data to other devices (e.g., simulated by other device models 232) or on to an application (e.g., 246). Further, the testing platform may process the acceptance of data at a device model from other sources (e.g., other device models or applications) and may cause the device models to generate synthesized responses to receiving the data. Such responses may include modeled behavior of one or more actuator assets corresponding to a device modeled by the respective device model. Such behavior may include the generation of still additional data by the device model responsive to receiving the data, among other examples. Based on the parameters and definition of a respective device model, simulated data and activity may be constant or variable. More complex device models may simulate battery life of the device and the effect of reduced battery life on communication amplitude, performance, etc., which may be manifest in the modeled data generated by the device model, among other examples.

As noted above, a testing platform 228 may execute a simulated IoT deployment within a particular physical environment modeled by a corresponding environment model (e.g., 230). The environment model may be populated such that various device models are associated with particular locations, positions, or coordinates defined within the environment model to simulate and correspond with the physical placement of corresponding devices at various places within the real physical environment. Populating the environment model to accurately model the relative locations of various devices within a deployment may further affect the behavior of various device models (e.g., those configured with parameters dictating sensitivities to environment factors or physical distances modeled by the environment model. As an example, if a particular device model is defined to be placed in a particular location within the environment modeled by the environment model, and that particular location is some distance away from another device (e.g., a gateway) with which the particular device is to communicate, and the distance extends to or beyond a limit of the transmission or communication capabilities of the particular device, the corresponding particular device model may be configured (based on its position defined in its population of the environment model) such that the data and behavior of the device model mimics that of the particular device being out-of-range of other partner devices (e.g., by modeling bit loss in data sent (generated) using the device model, a failure to pair or register with other devices, among other examples). In another example, a portion of an environmental model may model low temperatures within a particular portion of the modeled environment and placement of a device model within this portion of the environment may cause the device model (based on its parameters and as implemented in the testing platform) to behave in a manner consistent with the corresponding device being placed in the low temperature region (e.g., by modeling malfunction, faster battery degradation, etc.). The complexity and granularity of any device model may be configurable and may define response characteristics that are dependent on not only the inputs it receives (e.g., from an application (e.g., 246) or other device models (e.g., 232), but also on its virtual placement within a modeled environment, among other example considerations.

A testing platform 228 may additionally generate test data 237 in connection with its orchestration and management of a particular simulations involving a selected environment model 230 and a collection of device and/or asset models. For instance, the testing platform 228 may record the combination of the models (e.g., device and environment) used in the simulation, as well as the specific configurations (e.g., parameter values) employed in the models during the simulation. Further, the testing platform may log the synthesized data or modeled behaviors generated by the each of the device models, the data received from applications with which the simulated deployment interacted, and the responses of device models to this received data over the course of the simulation, among other information. The testing platform 228 may thereby generate a record of the simulation as embodied in test data 237. In some implementations, test data 237 may be used by analytics logic (e.g., error detection logic 210) to determine errors or abnormalities modeled in the simulation. In other examples, test data 237 may be utilized to replay the simulation for other users or as a modifiable template for subsequent simulations (e.g., which may modify one or more parameters or models in the prior simulation upon which the test data 237 is based), among other examples.

A GUI 212 of the IoT testing system 204 may provide views and interactive menus through which users may select, configure, and even create environment and device models to build various IoT deployment simulations. When the simulation is initiated and run (e.g., using testing platform 228) the GUI 212 may present graphical representations of the simulation, including graphical representations of the interactions, readings, device actions, and data communicated within the virtual simulation of a particular IoT deployment (e.g., based on the modeled data and behavior generated according to the constituent device models). Users may thereby view and observe a simulation and determine, in an intuitive manner, whether the IoT deployment operates in a semantically consistent manner and may iteratively adjust and run simulations to determine a plan for or improvements to a corresponding real-world IoT deployment, among other examples.

In some cases, a management system (e.g., 202) and/or an IoT testing system (e.g., 204) may each be implemented on a dedicated physical system (e.g., separate from other devices in system 200). For instance, management system 202 and/or IoT testing system 204 may each be implemented on a gateway device used to facilitate communication with and between multiple IoT devices (e.g., 105) in an IoT system (100, 101) deployed within a particular real-world environment. In some instances, management system 202 and/or IoT testing management system 204 may each be hosted, at least in part, on a user device (e.g., a personal computer), including a user device that may itself be utilized in the deployment of a particular IoT application associated with the IoT system (e.g., 100, 101). Indeed, management system 202 (and error detection logic 210) and/or IoT testing management system 204 may each be implemented on multiple devices (e.g., in a distributed deployment), with some functionality of the management system 202 and/or IoT testing management system 204 hosted on one device and other functionality hosted on at least one other device. A management system 202 and/or IoT testing system 204 may each be, in some cases, hosted partially or entirely remote from other elements of the system, such that functionality of the management system 202 and/or IoT testing system 204 is provided as a service to other elements. Indeed, management system 202 and/or IoT testing system 204 may each be implemented using one or more remote computing systems, such as cloud-based resources, and even fog-based resources, including implementations where all or a portion of the management system 202 and/or IoT testing system 204 are implemented on IoT endpoint devices, among other examples.

In one example, management system 202 can include functionality for deploying and managing deployments of IoT systems, including initializing one or more applications (e.g., 246) and configuring individual IoT devices to ensure successful interoperation of the components of the IoT system. In some implementations, the management system 202 may utilize results of an IoT system simulation carried out by the IoT testing system 204 to determine the manner in which a corresponding real-world system should be deployed. For instance, test data (e.g., 237) may be accessed, as generated in connection with a corresponding simulation, and the test data may be parsed to determine the configurations that were employed in the device models modeling the real-world devices to be deployed in the real-world system, and the management system 202 may cause these configurations to be pushed down and implemented within the real-world system, among other examples. Further, a management system may include error detection logic 210. In some cases, error detection logic 210 may be capable of detecting error conditions in a real-world deployment by comparing performance of the real-world system with test data 237 describing a corresponding simulated deployment run using a testing system 204. For instance, the test data 237 may correspond to or be flagged (e.g., by a user or a system) as representing an error and detecting that the real-world system behaves similar to the error-prone simulation may cause the error detection module 210 to identify an error in the real-world system. In another example, a corresponding simulation described in test data 237 may be considered a representation of a successful deployment and may be used as a baseline to determine whether the corresponding real-world deployment is also functioning as expected or deviates from the expected behavior determined from the simulation, among other examples.

As noted, one or more application servers (e.g., 206) may be provided to host application(s) 246 with which one or more devices in an IoT deployment may interact during operation. In one example, an application server 206 may include one or more data processing apparatus 238, one or more memory elements 240, and one or more communication modules 242 incorporating hardware and logic to allow the application server 206 to communicate over one or more networks (e.g., 120) (e.g., with devices in a real-world IoT deployment (e.g., 100/101), a gateway or other device aggregating data of other devices within the deployment, a testing system 204 orchestrating communications of modeled devices with the application(s) 246, a user device 208, etc.). The application server 206 may further run an operating system 244 and one or more IoT applications (e.g., 246). The application(s) 246 may consume and/or generate various data 248, some of which is based on data received from real or virtualized IoT deployments. In some implementations, all or a portion of an example application server (e.g., 206) may be implemented on an IoT management system 202, an IoT gateway, or even on one or a collection of IoT devices, among other examples.

A user device (e.g., 208) may be any computing device known in the art or developed in the future that enable a user to communicate with system 200. Personal computers (e.g., desk top computing devices, laptop computing devices, etc.), smart phones, tablet devices, and purpose-built computing devices, among other examples, are examples of a user device 208.

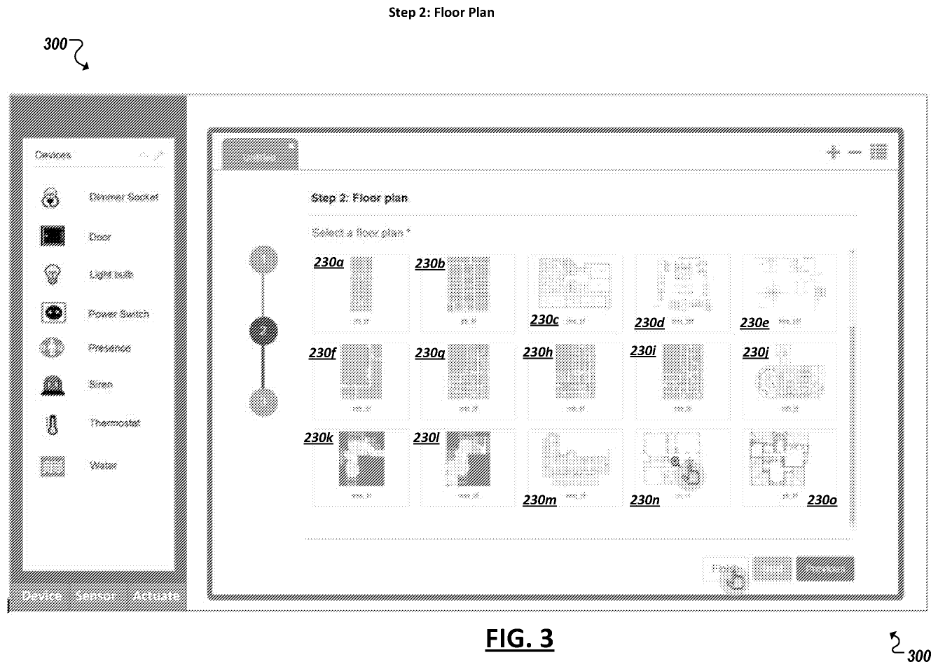

Turning to the simplified diagram 300 of FIG. 3, a representation is shown of an example library of IoT testing environments (e.g., 230). The illustrated example library of IoT testing environments 230 is presented to a user as a graphical user interface (GUI), among other examples of user interfaces (UIs), and provides IoT testing environments 230a-230o for selection (e.g., via an IoT testing environment manager (e.g., 218)) for use in an IoT testing model (e.g., 234). While the example in FIG. 3 illustrates a particular number (i.e., fifteen) of IoT testing environments 230 (e.g., represented by corresponding floorplans), other examples may provide a greater number or a fewer number of IoT testing environments for selection by a user. An IoT testing environment 230 can be selected using any one or more selection techniques (e.g., a drag-and-drop technique and a mouse clicking technique, among other examples). As discussed above, each IoT testing environment 230 may be generated (e.g., using an IoT testing environment generator (e.g., 222)) from scratch and/or may be generated with a defined set of parameters or blueprints provided that each IoT testing environment 230 models a real-world environment (e.g., a building, room, etc.) within which an IoT system (e.g., 100, 101) can be deployed.

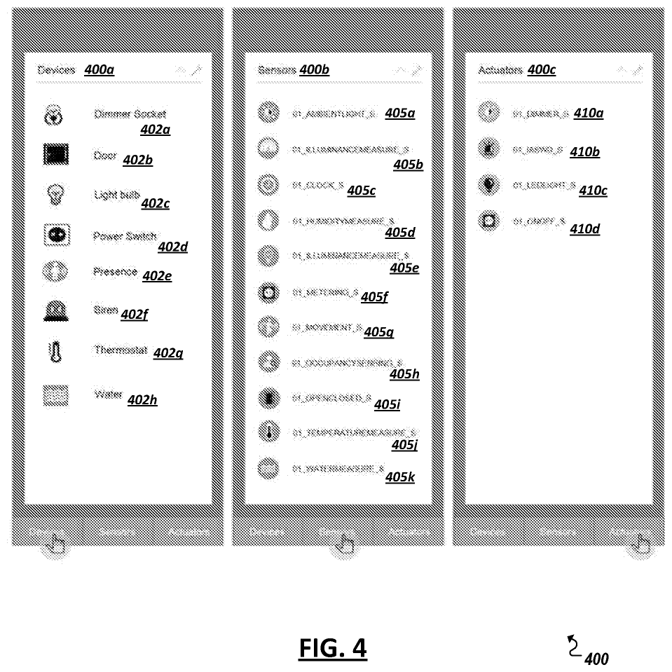

In addition to facilitating the selection of an IoT testing environment for a particular IoT system simulation, GUIs provided through an example test system may additionally permit users to define, create, or modify one or more device models to be placed in, or populate, the selected testing environment model. In some instances, predefined device models or device model templates may be provided. For instance, as shown in the example GUI interface diagrams of FIG. 4, a collection of pre-defined device models (e.g., 402a-h) may be presented in a particular window 400a (e.g., by selecting a “Devices” tab) to allow a user to directly select one or more instances of various pre-defined device models for placement within the IoT testing environment. For instance, a user may select a device model and selection of the device model may cause additional GUI windows to be presented to a user to allow the user to customize parameter values defined for the device model. In this example, device models may correspond to various uni-modal or multi-modal IoT devise such as a dimmer socket 402a, an automated door 402b (e.g., automated by a door open sensor and/or automated door opener actuator, etc.), a smart thermostat (e.g., 402g), among other examples.

Continuing with the example of FIG. 4, GUI windows may additionally be presented to permit a user to select from libraries of IoT asset models. For instance, selection of a “Sensors” tab may cause another window 400b to be presented to display a listing of various asset models (e.g., 405a-k) which may be selected by a user to display descriptive information about the respective models and/or implement the asset models within a device model that models a real-world device that includes one or more instances of the corresponding sensor (or instances of different sensors). For instance, a GUI may be provided through which a user may custom define a device model corresponding to a particular IoT device. The GUI may allow device model representation 405a-k to be selected to build a definition for the new device model. For instance, a smart home device may include an occupancy sensor, door open/closed sensor, and ambient light sensors to intelligently manage lights within a home. To build the corresponding device model, a user may select the inclusion of an ambient light sensor asset model 405a, an occupancy sensor asset model 405h, and door open sensor model 405i. Further, actuators present in the device may also be accounted for by selecting actuator asset models 410a-d (e.g., using a GUI window 400c), such as a dimmer switch actuator asset model 410a, LED light control actuator asset model 410b, and outlet on/off switch actuator asset model 410d, among other examples. The selected asset models (e.g., 405a, 405h, 405i, 410a, 410b, 410d) may be included within the new device model developed using the device model generator. A user may then further configure the various parameters defined in each model to further customize the device model and tune it to accurately simulate the smart home IoT device, among other examples.

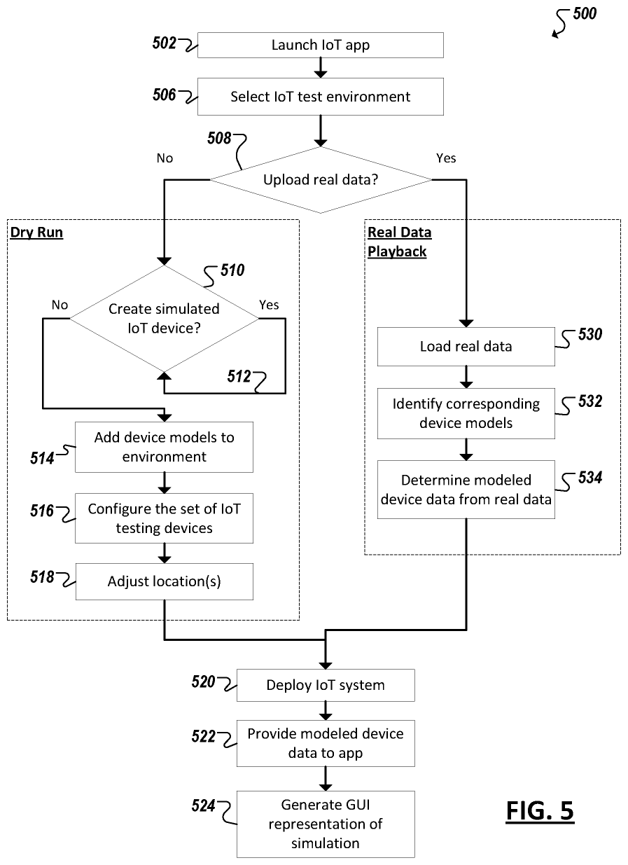

FIG. 5 is a simplified flow diagram 500 illustrating an example technique for simulating an example IoT deployment using an example IoT testing system. For instance, one or more IoT applications may be launched 502, which are to be utilized by a real-world IoT system to be modeled in a particular IoT system simulation. A test environment model may be selected 506 that models a physical environment in which the real-world IoT system is to be deployed. The modeled IoT system may be a system that is either already deployed or may be a hypothetical or planned deployment. In some cases, the deployment may be based on another deployment (e.g., using the same or a similar collection of devices) but for a different location (e.g., modeled by the selected IoT test environment model).

Device models may be provisioned within the simulation to simulate various devices to be included in hypothetical or real-world deployments. Device models may be based from and model real-world devices, but may also model arbitrary devices, either real-world or artificial, existing or planned. In some instances, real data describing a real world deployment (e.g., in an environment different from or the same as the environment modeled by the selected test environment model) may be utilized to automate the selection and configuration of a set of device models for a particular IoT system simulation. If such real data is available (as determined at 508), the real data may be loaded 530 and corresponding device models may be identified 532. This may involve selecting pre-defined device models that most closely approximate the real-world devices described in the real data, configuring such device models, or even generating new device models (e.g., by selecting the component asset models corresponding to a collection of assets determined for each of the real devices from the real data), among other examples. Further, real data may describe data and behaviors actually observed in the real devices within an example real-world deployment. In such instances, the recorded data may be provided (e.g., at 534) to the device models and may be “played-back” within the simulation (e.g., rather than the device model logic generating synthetic data from scratch).

If real data is not to be used to select device models for a given simulation, a user may be permitted to create (at 510) or select (at 510) a collection of various device models to represent the collection of devices to be included in a modeled real-world deployment. In some cases, a mix of device models generated from real data (e.g., at 530-534) and through user selection (e.g., 510) may be incorporated within the same simulation. In the case of user-defined models, device models may be selected and added 514 to the selected test environment model and parameters of the device models may configured 516 to cause the device models to behave in a manner desired for the simulation (e.g., to approximate a real-world version of the corresponding IoT device (e.g., as it is implemented or as it is planned to be implemented)).

In some cases, an IoT testing system may allow a user to specify (at 518) the specific placement of each of the device models within the selected test environment model, to represent the physical locations of each of the real-world devices in the real-world environment represented by the environment model. In some cases, real data may parsed to specify the locations of device models derived (or selected) based on the real data. In other instances, locations of these device models (i.e., based on real data) may also be adjusted to specify the simulated locations of corresponding devices within a physical environment.

With the environment model selected and the device models selected and configured and positioned within the modeled environment (to populate the test environment model), the IoT system simulation may be deployed 520 or run. This may cause modeled, synthetic data to be generated at one or more of the device models to simulate data and behavior of the corresponding real-world devices (and their component assets). Such data may be directed (by the testing system) to be provided as inputs to other device models (which, in turn, may cause response behavior to modeled at the received device model) and/or to the launched application (at 522). In response to receiving this modeled device data (delivered via an application interface of the testing system), the application may regard the device data as any other data that it might receive and process from a live, real-world device or IoT system deployment and respond, based on the specific logic and functionality of the application. Indeed, in some implementations, the application may respond by sending data back to the modeled devices (through the application interface) and the testing system may simulate the delivery or communication of this application data to a corresponding device model (which may also model behavior or further data generation responsive to this application data (e.g., based on one or more actuator asset models included in the device model)), among other examples. A graphical representation of the virtual IoT system deployment may be presented in a GUI generated to correspond to the simulation. For instance, the graphical representation may include a representation of the selected physical environment, representations of the placement of each of the various modeled devices, and may even graphically represent data generated by or other behaviors of each respective modeled device. In this manner, the GI may provide a user with a simulated view of how a corresponding real-world IoT deployment would function (e.g., in connection with one or more particular IoT applications) to determine whether the deployment would be satisfactory and/or to identify semantic errors in the IoT system, among other information.

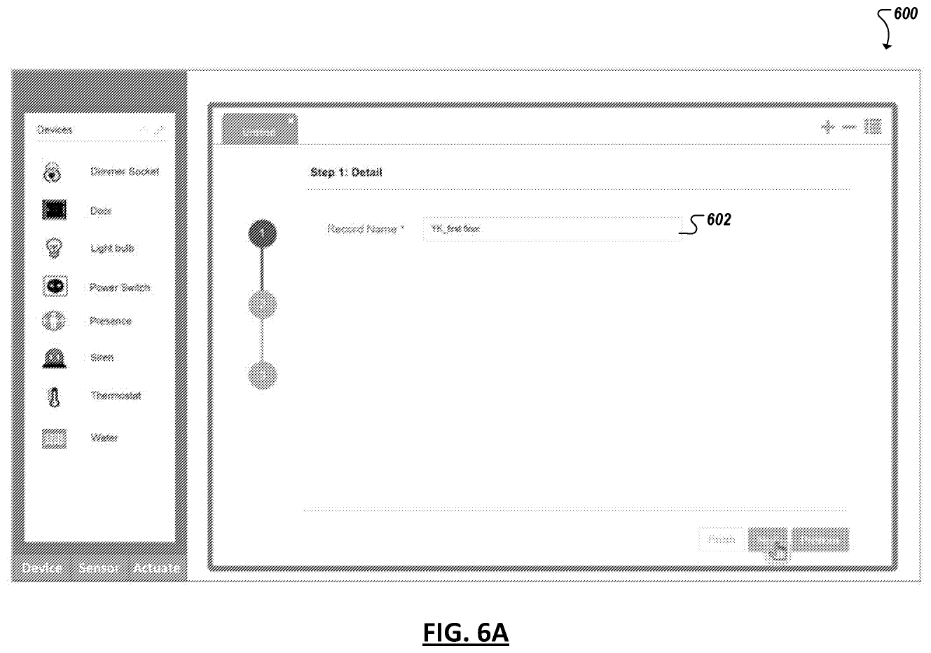

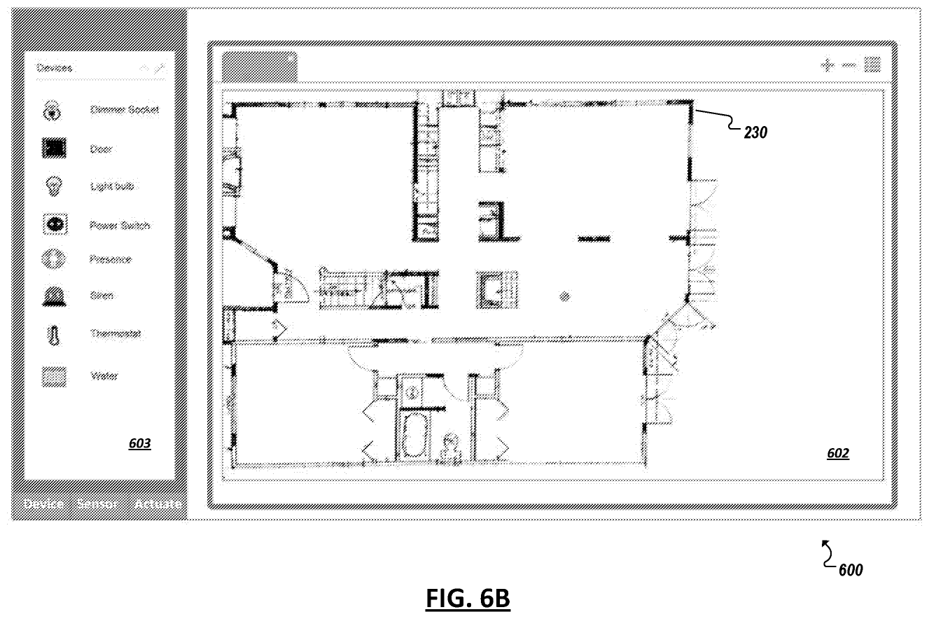

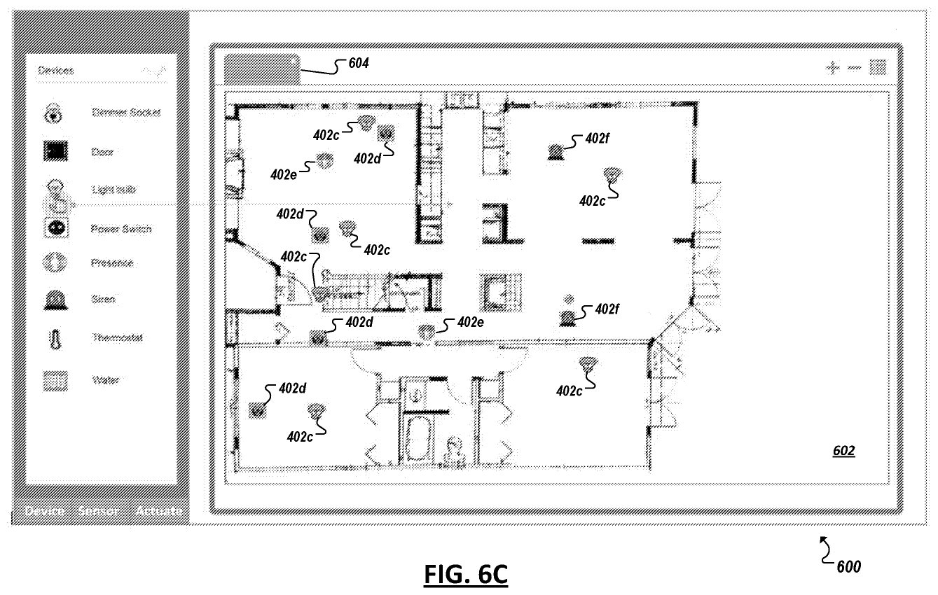

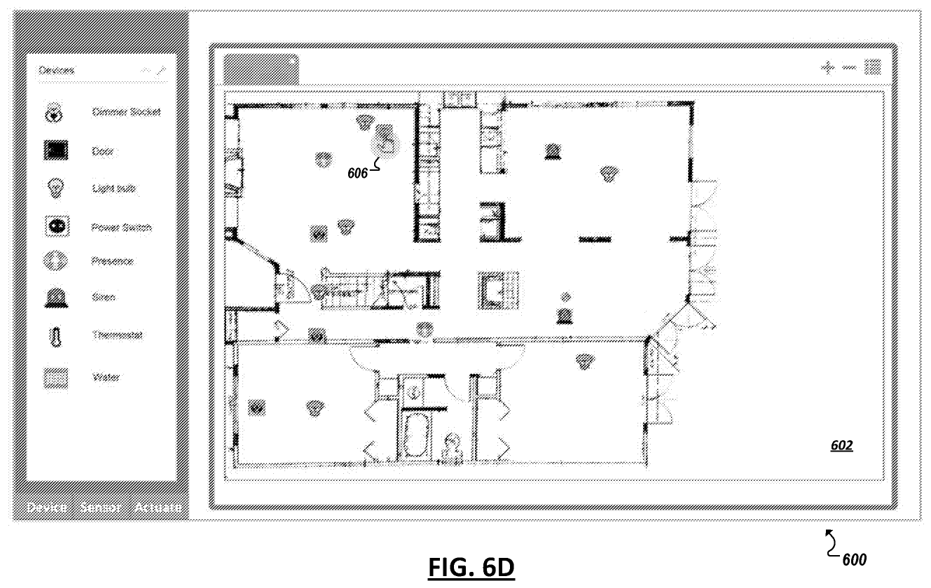

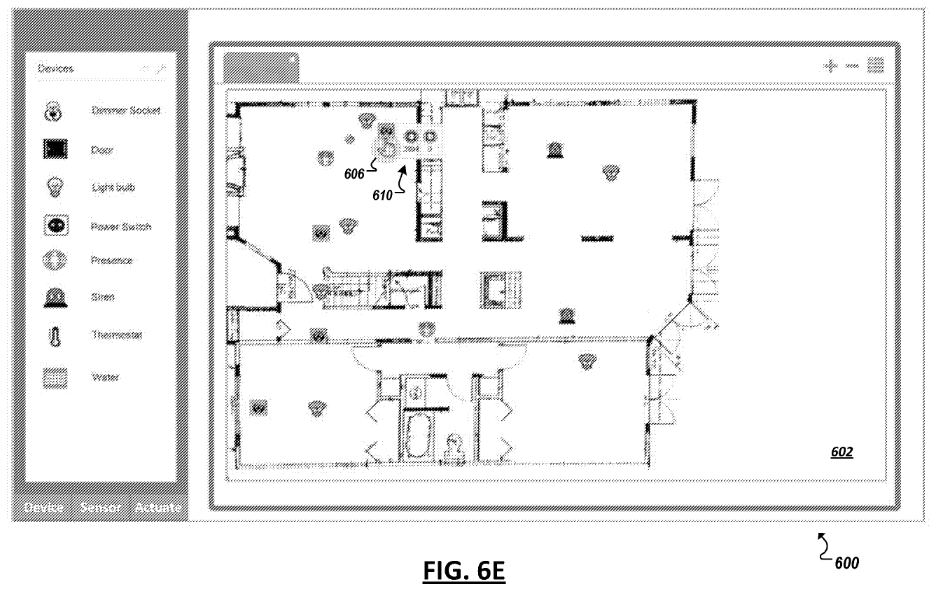

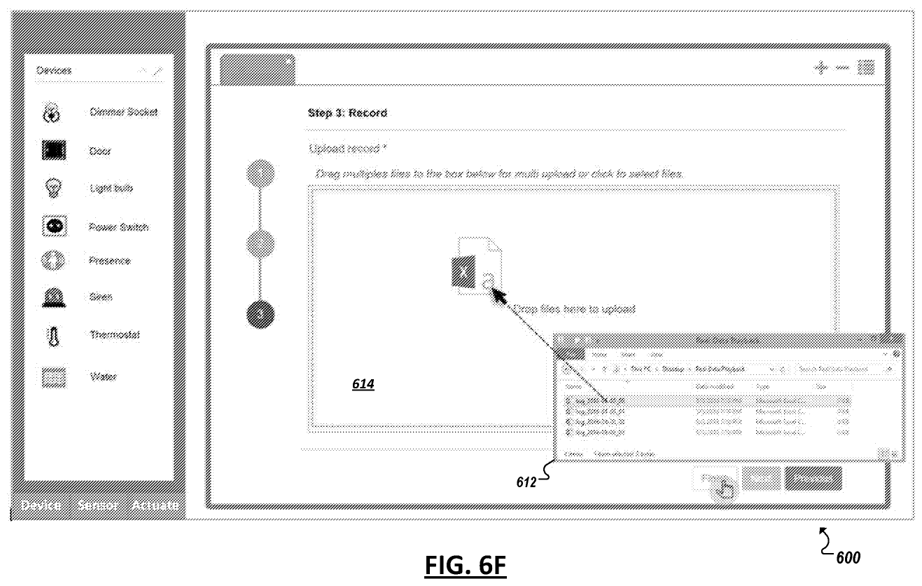

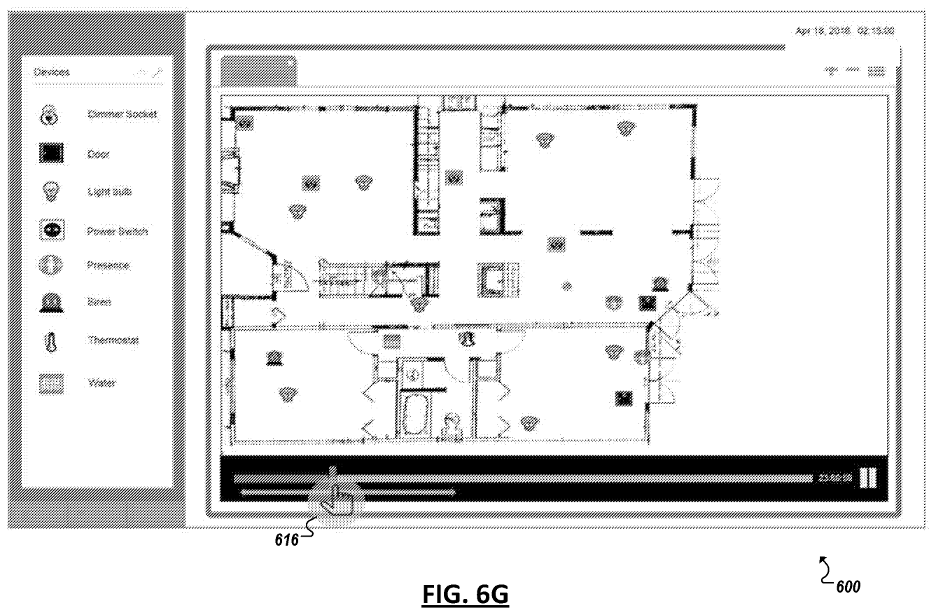

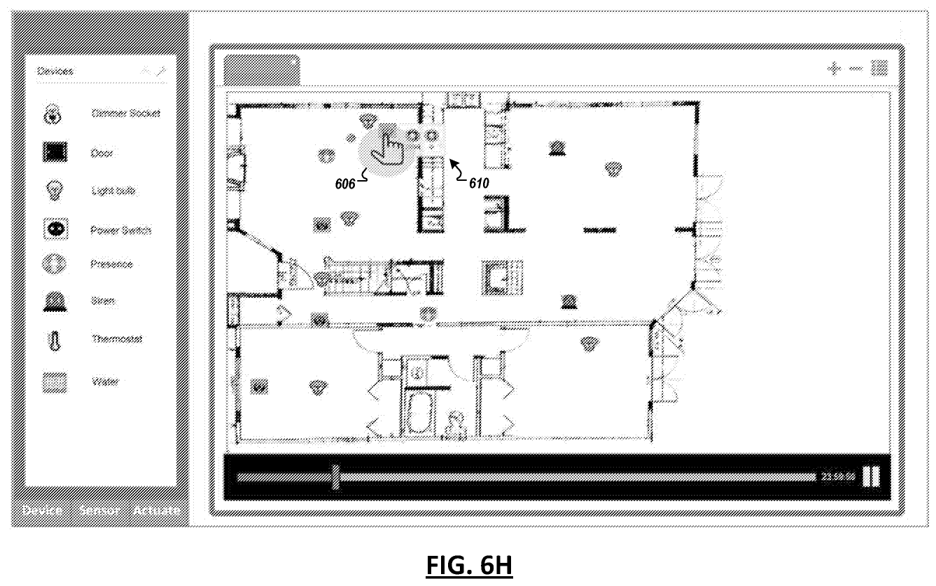

FIGS. 6A-6I illustrate a simplified example GUI 600 to generate and launch an example IoT simulation. For instance, beginning with the example illustrated in FIG. 6A, a GUI 600 can include a field 602 to receive a name for the simulation (e.g., from which a corresponding test data file may be created to record and describe the IoT simulation to be developed and run). In FIG. 6B, a particular environment model 230 may be selected and may be displayed within a simulation building window 602. Further, a device model selection window 603 (e.g., similar to window 400a in FIG. 4) may be additionally provided, from which a user may select various device models to populate the environment modeled by the selected environment 230. For instance, as shown in FIG. 6C, a user may select various device models from the selection window 603 and drag and drop a corresponding icon (representing a corresponding device model instance) at a location within the graphical representation of the test environment (provided by the environment model) that corresponds to a desired physical location for the modeled device instance. In the example of FIG. 6C, multiple instances of various device models have been selected to populate the test environment, including multiple instances of a device models 402c, 402d, 402e, and 402f.

Turning to FIG. 6D, after populating the test environment with a collection of device models, a user may select icons (using cursor 606) corresponding to individual device model instances to allow additional windows to be presented to the user through which the specific parameters of each individual device model may be configured. With the environment model populated with device models, and the parameters of device models set to accurately modeled the desired real-world deployment, a user may instruct (via another input or interaction with the GUI) that the simulation is to be started. This may further involve identifying and accessing an IoT application with which the simulation is to interact. As shown in FIG. 6E, the various device models, when run, may generate synthetic device data (e.g., corresponding to the various sensor and/or compute asset models included in the device model and the parameters set for each). This synthetic data may be sent outside of the test environment to an IoT application to test how the IoT system would integrate or interoperate with the IoT application. Additionally, graphic display elements (e.g., 610) may be provided to identify values of the data being generated by various assets on each modeled device in the simulation. For instance, in the example of FIG. 6E, upon using a cursor 606 to select or hover over a particular graphical representation of a particular one of the deployed device models, display elements 610 may be presented for each asset included on the modeled device to indicate the simulated data values or state changes being generated by the corresponding device model logic (and/or asset model logic). Similar displays may be presented for any one of the device models, either as corresponding graphical icons are selected or as the simulation is run (e.g., displays may be shown concurrently for all of the device models in the simulation), among other examples. In this manner, a user can observe how the modeled deploy functions during the simulation. Information may also be displayed or logged to describe the manner in which any IoT applications interfacing with the simulation are responding to or communicating with the simulation, to further assist the user in identifying the success of the virtual IoT deployment, among other example features.

Turning to the examples of FIGS. 6F-6H, as noted above, real data describing an observed real-world IoT deployment, may be utilized to automatically provision an IoT system with a corresponding simulation of the real-world deployment. For instance, in FIG. 6F, a user may drag and drop a file (at 612) into a recording pane 614 to provide the testing system with the real data. The testing system may then parse the real data to identify one or more of the device models to be used to simulate devices in the real world deployment, the environment model to simulate the real-world environment, placement information describing how the device are positioned within the environment (from which the environment model may be automatically populated with the corresponding device models), and modeled device data corresponding to the actual data generated by the real-world devices (and their composite assets) in the real-world deployment, among other information. In some implementations, the real data may be sufficient to construct a full simulation, which may be run to playback the actual observed behavior of the real-world system for analysis by a user. For instance, as shown in FIG. 6G, real data may be processed to build a graphical representation of the deployment (e.g., based on environment models and device models identified for the representation). In one example implementations, a playback slider control 616 may be provided, through which a user may control the playback of the modeled real-world deployment, such that the user may observe (e.g., in a manner similar to the example shown in FIG. 6E of a dry run simulation) how the various devices and assets in the real-world deployment performed over time. For instance, as shown in FIG. 6H, display elements 610 may likewise be provided in real-data-based playbacks, through which a user may observe the data values and/or state actually generated or implemented during the recording of the real-world deployment. This graphical representation may allow a user managing the real-world deployment to more easily visualize how the entire deployment is functioning, and further identify whether semantic errors exist in the system, among other example uses.

While some of the systems and solution described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

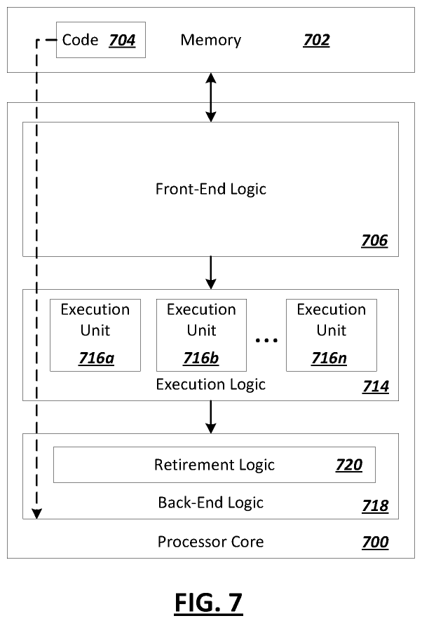

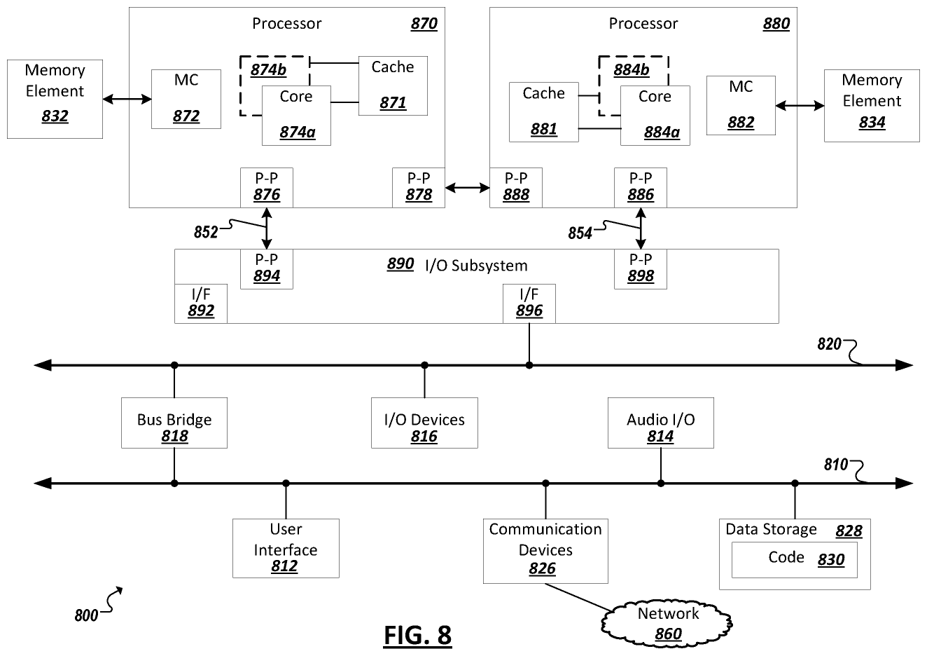

FIGS. 7-8 are block diagrams of exemplary computer architectures that may be used in accordance with embodiments disclosed herein. Other computer architecture designs known in the art for processors and computing systems may also be used. Generally, suitable computer architectures for embodiments disclosed herein can include, but are not limited to, configurations illustrated in FIGS. 7-8.

FIG. 7 is an example illustration of a processor according to an embodiment. Processor 700 is an example of a type of hardware device that can be used in connection with the implementations above. Processor 700 may be any type of processor, such as a microprocessor, an embedded processor, a digital signal processor (DSP), a network processor, a multi-core processor, a single core processor, or other device to execute code. Although only one processor 700 is illustrated in FIG. 7, a processing element may alternatively include more than one of processor 700 illustrated in FIG. 7. Processor 700 may be a single-threaded core or, for at least one embodiment, the processor 700 may be multi-threaded in that it may include more than one hardware thread context (or “logical processor”) per core.

FIG. 7 also illustrates a memory 702 coupled to processor 700 in accordance with an embodiment. Memory 702 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 700 can execute any type of instructions associated with algorithms, processes, or operations detailed herein. Generally, processor 700 can transform an element or an article (e.g., data) from one state or thing to another state or thing.

Code 704, which may be one or more instructions to be executed by processor 700, may be stored in memory 702, or may be stored in software, hardware, firmware, or any suitable combination thereof, or in any other internal or external component, device, element, or object where appropriate and based on particular needs. In one example, processor 700 can follow a program sequence of instructions indicated by code 704. Each instruction enters a front-end logic 706 and is processed by one or more decoders 708. The decoder may generate, as its output, a micro operation such as a fixed width micro operation in a predefined format, or may generate other instructions, microinstructions, or control signals that reflect the original code instruction. Front-end logic 706 also includes register renaming logic 710 and scheduling logic 712, which generally allocate resources and queue the operation corresponding to the instruction for execution.

Processor 700 can also include execution logic 714 having a set of execution units 716a, 716b, 716n, etc. Some embodiments may include a number of execution units dedicated to specific functions or sets of functions. Other embodiments may include only one execution unit or one execution unit that can perform a particular function. Execution logic 714 performs the operations specified by code instructions.

After completion of execution of the operations specified by the code instructions, back-end logic 718 can retire the instructions of code 704. In one embodiment, processor 700 allows out of order execution but requires in order retirement of instructions. Retirement logic 720 may take a variety of known forms (e.g., re-order buffers or the like). In this manner, processor 700 is transformed during execution of code 704, at least in terms of the output generated by the decoder, hardware registers and tables utilized by register renaming logic 710, and any registers (not shown) modified by execution logic 714.

Although not shown in FIG. 7, a processing element may include other elements on a chip with processor 700. For example, a processing element may include memory control logic along with processor 700. The processing element may include I/O control logic and/or may include I/O control logic integrated with memory control logic. The processing element may also include one or more caches. In some embodiments, non-volatile memory (such as flash memory or fuses) may also be included on the chip with processor 700.

FIG. 8 illustrates a computing system 800 that is arranged in a point-to-point (PtP) configuration according to an embodiment. In particular, FIG. 8 shows a system where processors, memory, and input/output devices are interconnected by a number of point-to-point interfaces. Generally, one or more of the computing systems described herein may be configured in the same or similar manner as computing system 800.

Processors 870 and 880 may also each include integrated memory controller logic (MC) 872 and 882 to communicate with memory elements 832 and 834. In alternative embodiments, memory controller logic 872 and 882 may be discrete logic separate from processors 870 and 880. Memory elements 832 and/or 834 may store various data to be used by processors 870 and 880 in achieving operations and functionality outlined herein.

Processors 870 and 880 may be any type of processor, such as those discussed in connection with other figures. Processors 870 and 880 may exchange data via a point-to-point (PtP) interface 850 using point-to-point interface circuits 878 and 888, respectively. Processors 870 and 880 may each exchange data with a chipset 890 via individual point-to-point interfaces 852 and 854 using point-to-point interface circuits 876, 886, 894, and 898. Chipset 890 may also exchange data with a high-performance graphics circuit 838 via a high-performance graphics interface 839, using an interface circuit 892, which could be a PtP interface circuit. In alternative embodiments, any or all of the PtP links illustrated in FIG. 8 could be implemented as a multi- drop bus rather than a PtP link.

Chipset 890 may be in communication with a bus 820 via an interface circuit 896. Bus 820 may have one or more devices that communicate over it, such as a bus bridge 818 and I/O devices 816. Via a bus 810, bus bridge 818 may be in communication with other devices such as a user interface 812 (such as a keyboard, mouse, touchscreen, or other input devices), communication devices 826 (such as modems, network interface devices, or other types of communication devices that may communicate through a computer network 860), audio I/O devices 814, and/or a data storage device 828. Data storage device 828 may store code 830, which may be executed by processors 870 and/or 880. In alternative embodiments, any portions of the bus architectures could be implemented with one or more PtP links.

The computer system depicted in FIG. 8 is a schematic illustration of an embodiment of a computing system that may be utilized to implement various embodiments discussed herein. It will be appreciated that various components of the system depicted in FIG. 8 may be combined in a system-on-a-chip (SoC) architecture or in any other suitable configuration capable of achieving the functionality and features of examples and implementations provided herein.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The following examples pertain to embodiments in accordance with this Specification. Example 1 is a machine accessible storage medium having instructions stored thereon, the instructions when executed on a machine, cause the machine to: define a simulation to include a particular test environment and one or more device models, where each device model simulates a respective device, the test environment simulates a physical environment, and the one or more device models are populated in the IoT testing environment to model a deployment of devices corresponding to the device models in the physical environment; generate, based on the one or more device models, modeled device data to simulate data generated by corresponding devices; transmit the modeled device data to an application; and receive application data from the application based on the modeled device data.

Example 2 may include the subject matter of Example 1, where the instructions, when executed, further cause the machine to generate a modeled response of the one or more IoT asset models based on the application data.

Example 3 may include the subject matter of Example 2, where the modeled response includes a modeled action of an actuator of the devices.

Example 4 may include the subject matter of Example 2, where the modeled response includes generation of modeled response data of the devices.

Example 5 may include the subject matter of any one of Examples 1-4, where the device model simulates a particular multi-modal device including a plurality of assets and the IoT asset model includes a plurality of asset models to model the respective plurality of assets.

Example 6 may include the subject matter of Example 5, where the plurality of assets includes at least one of a sensor type asset and an actuator type asset.

Example 7 may include the subject matter of Example 5, where the instructions, when executed, further cause the machine to: receive user inputs to select each of the asset models from a library of asset models corresponding to respective assets; and generate the device model based on the user input.

Example 8 may include the subject matter of any one of Examples 1-7, where the instructions, when executed, further cause the machine to receive a user input to select the test environment from a library including a plurality of test environment models.

Example 9 may include the subject matter of any one of Examples 1-8, where the test environment is automatically populated with the one or more device models based on deployment data describing a real-world deployment of the one or more devices.

Example 10 may include the subject matter of Example 9, where the instructions, when executed, further cause the machine to: identify the one or more devices from the deployment data; and select the device models from a library of device models to correspond to the one or more devices.

Example 11 may include the subject matter of any one of Examples 1-10, where the instructions, when executed, further cause the machine to: determine modeled locations of each of the one or more device models in the physical environment modeled by the test environment.

Example 12 may include the subject matter of Example 11, where the one or more devices include a plurality of devices, the one or more device models include a corresponding plurality of device models, and the instructions, when executed, further cause a machine to determine modeled physical distances between two or more of the device models based on the modeled locations, and behavior of at least a particular one of the two or more device models is modeled to be affected by the modeled physical distance.

Example 13 may include the subject matter of any one of Examples 1-12, where the one or more device models include a particular set of device models and the instructions, when executed, further cause the machine to receive a user input to select, from a library of device models, one or more of the particular set of device models, where the test environment is to be populated with the device models based on the user input.

Example 14 may include the subject matter of any one of Examples 1-13, where at least a particular one of the one or more device models includes a configurable model and a set of parameters, where behavior of the particular device model is based on values of the set of parameters.

Example 15 may include the subject matter of Example 14, where the instructions, when executed, further cause the machine to receive a user input to define a value of at least one of the set of parameters for use in the simulation.

Example 16 may include the subject matter of Example 14, where at least a particular one of the set of parameters includes predefined parameter values to correspond to parameters of the device modeled by the particular device model.

Example 17 may include the subject matter of Example 14, where the set of parameters includes one or more of a battery parameter corresponding to behavior of a battery of a corresponding device, a sensor parameter corresponding to behavior of a sensor of the corresponding device, an actuator parameter corresponding to behavior of an actuator of the corresponding device, and a communication parameter corresponding to behavior of a communication module of the corresponding device.

Example 18 may include the subject matter of Example 14, where the modeled device data models data generated by one or more sensors of the corresponding device.

Example 19 may include the subject matter of any one of Examples 1-18, where the application is adapted to receive data generated from the devices in a real-world deployment.

Example 20 may include the subject matter of Example 19, where the modeled device data is to be sent over an interface to the application to simulate data sent in association with the real-world deployment.

Example 21 may include the subject matter of any one of Examples 1-20, where the instructions, when executed, further cause the machine to generate an interactive graphical representation of the physical environment including graphical elements indicating placement of the one or more devices corresponding to the one or more device models in the physical environment modeled by the test environment.

Example 22 may include the subject matter of Example 21, where values of modeled device data generated during the simulation are to be presented in the graphical representation.

Example 23 is a method including: populating a test environment with one or more device models, where each device model simulates a respective device, the test environment simulates a physical environment, and the one or more device models are populated in the IoT testing environment to model a deployment of devices corresponding to the device models in the physical environment; generating, based on the one or more device models, modeled device data to simulate data generated by corresponding devices; transmitting the modeled device data to an application; receiving application data from the application based on the modeled device data; and generating modeled responses, by at least some of the one or more device models, to the application data.

Example 24 may include the subject matter of Example 23, further including generating a modeled response of the one or more IoT asset models based on the application data.

Example 25 may include the subject matter of Example 24, where the modeled response includes a modeled action of an actuator of the devices.

Example 26 may include the subject matter of Example 24, where the modeled response includes generation of modeled response data of the devices.

Example 27 may include the subject matter of any one of Examples 23-26, where the device model simulates a particular multi-modal device including a plurality of assets and the IoT asset model includes a plurality of asset models to model the respective plurality of assets.

Example 28 may include the subject matter of Example 27, where the plurality of assets includes at least one of a sensor type asset and an actuator type asset.

Example 29 may include the subject matter of Example 27, further including: receiving user inputs to select each of the asset models from a library of asset models corresponding to respective assets; and generating the device model based on the user input.

Example 30 may include the subject matter of any one of Examples 23-29, further including receiving a user input to select the test environment from a library including a plurality of test environment models.

Example 31 may include the subject matter of any one of Examples 23-30, where the test environment is automatically populated with the one or more device models based on deployment data describing a real-world deployment of the one or more devices.

Example 32 may include the subject matter of Example 31, further including: identifying the one or more devices from the deployment data; and selecting the device models from a library of device models to correspond to the one or more devices.

Example 33 may include the subject matter of any one of Examples 23-32, further including determining modeled locations of each of the one or more device models in the physical environment modeled by the test environment.

Example 34 may include the subject matter of Example 33, where the one or more devices include a plurality of devices, the one or more device models include a corresponding plurality of device models, and the method further includes determining modeled physical distances between two or more of the device models based on the modeled locations, and behavior of at least a particular one of the two or more device models is modeled to be affected by the modeled physical distance.

Example 35 may include the subject matter of any one of Examples 23-34, where the one or more device models include a particular set of device models and the instructions, when executed, further cause the machine to receive a user input to select, from a library of device models, one or more of the particular set of device models, where the test environment is to be populated with the device models based on the user input.

Example 36 may include the subject matter of any one of Examples 23-35, where at least a particular one of the one or more device models includes a configurable model and a set of parameters, where behavior of the particular device model is based on values of the set of parameters.

Example 37 may include the subject matter of Example 36, further including receiving a user input to define a value of at least one of the set of parameters for use in the simulation.

Example 38 may include the subject matter of Example 36, where at least a particular one of the set of parameters includes predefined parameter values to correspond to parameters of the device modeled by the particular device model.

Example 39 may include the subject matter of Example 36, where the set of parameters includes one or more of a battery parameter corresponding to behavior of a battery of a corresponding device, a sensor parameter corresponding to behavior of a sensor of the corresponding device, an actuator parameter corresponding to behavior of an actuator of the corresponding device, and a communication parameter corresponding to behavior of a communication module of the corresponding device.

Example 40 may include the subject matter of Example 36, where the modeled device data models data generated by one or more sensors of the corresponding device.

Example 41 may include the subject matter of any one of Examples 23-40, where the application is adapted to receive data generated from the devices in a real-world deployment.

Example 42 may include the subject matter of Example 41, where the modeled device data is to be sent over an interface to the application to simulate data sent in association with the real-world deployment.

Example 43 may include the subject matter of any one of Examples 23-42, further including generating an interactive graphical representation of the physical environment including graphical elements indicating placement of the one or more devices corresponding to the one or more device models in the physical environment modeled by the test environment.

Example 44 may include the subject matter of Example 43, where values of modeled device data generated during the simulation are to be presented in the graphical representation.

Example 45 is a system that includes means to perform the method of any one of Examples 23-44.

Example 46 is a system including: a data processor device; computer memory to store a plurality of device models, where each of the plurality of device models includes logic to model behavior of a respective device, and at least one Internet of Things (IoT) environment model to model a physical environment; and an Internet of Things (IoT) testing system. The IoT testing system may be executable by the data processor device to: populate the IoT testing environment with a set of device models from the plurality of device models to model a deployment of devices corresponding to the IoT asset models in the physical environment; generate, based on the one or more device models, modeled device data to simulate data generated by corresponding devices; transmit the modeled device data to an application; and receive particular application data from the application based on the modeled device data.

Example 47 may include the subject matter of Example 46, further including the application, where the application is executable to: receive device data from real or modeled devices in a real or simulated deployment; process the device data; and generate application data based on the processing of the device data, where the particular application data is generated based on receiving and processing the modeled device data.

Example 48 may include subject matter of any one of Examples 46-47, further including the deployment of devices.

Example 49 may include the subject matter of Example 48, where the IoT testing system interfaces with one or more devices in the deployment of devices.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1. At least one machine accessible storage medium having instructions stored thereon, the instructions when executed on a machine, cause the machine to:
define a simulation to include a particular test environment and one or more device models, wherein each device model simulates a respective device, the test environment simulates a physical environment, and the one or more device models are populated in the IoT testing environment to model a deployment of devices corresponding to the device models in the physical environment;
generate, based on the one or more device models, modeled device data to simulate data generated by corresponding devices;
transmit the modeled device data to an application; and
receive application data from the application based on the modeled device data.

2. The storage medium of claim 1, wherein the instructions, when executed, further cause the machine to generate a modeled response of the one or more IoT asset models based on the application data.

3. (canceled)

4. (canceled)

5. The storage medium of claim 1, wherein the device model simulates a particular multi-modal comprising a plurality of assets and the IoT asset model comprises a plurality of asset models to model the respective plurality of assets.

6. (canceled)

7. (canceled)

8. The storage medium of claim 1, wherein the instructions, when executed, further cause the machine to receive a user input to select the test environment from a library comprising a plurality of test environment models.

9. The storage medium of claim 1, wherein the test environment is automatically populated with the one or more device models based on deployment data describing a real-world deployment of the one or more devices.

10. The storage medium of claim 9, wherein the instructions, when executed, further cause the machine to:
identify the one or more devices from the deployment data;
select the device models from a library of device models to correspond to the one or more devices.

11. The storage medium of claim 1, wherein the instructions, when executed, further cause the machine to:
determine modeled locations of each of the one or more device models in the physical environment modeled by the test environment.

12. The storage medium of claim 11, wherein the one or more devices comprise a plurality of devices, the one or more device models comprise a corresponding plurality of device models, and the instructions, when executed, further cause a machine to determine modeled physical distances between two or more of the device models based on the modeled locations, and behavior of at least a particular one of the two or more device models is modeled to be affected by the modeled physical distance.

13. The storage medium of claim 1, wherein the one or more device models comprise a particular set of device models and the instructions, when executed, further cause the machine to receive a user input to select, from a library of device models, one or more of the particular set of device models, wherein the test environment is to be populated with the device models based on the user input.

14. The storage medium of claim 1, wherein at least a particular one of the one or more device models comprises a configurable model and a set of parameters, wherein behavior of the particular device model is based on values of the set of parameters.

15. The storage medium of claim 14, wherein the instructions, when executed, further cause the machine to receive a user input to define a value of at least one of the set of parameters for use in the simulation.

16. The storage medium of claim 14, wherein at least a particular one of the set of parameters comprises predefined parameter values to correspond to parameters of the device modeled by the particular device model.

17. The storage medium of claim 14, wherein the set of parameters comprises one or more of a battery parameter corresponding to behavior of a battery of a corresponding device, a sensor parameter corresponding to behavior of a sensor of the corresponding device, an actuator parameter corresponding to behavior of an actuator of the corresponding device, and a communication parameter corresponding to behavior of a communication module of the corresponding device.

18. The storage medium of claim 14, wherein the modeled device data models data generated by one or more sensors of the corresponding device.

19. The storage medium of claim 1, wherein the application is adapted to receive data generated from the devices in a real-world deployment.

20. The storage medium of claim 19, wherein the modeled device data is to be sent over an interface to the application to simulate data sent in association with the real-world deployment.

21. The storage medium of claim 1, wherein the instructions, when executed, further cause the machine to generate an interactive graphical representation of the physical environment comprising graphical elements indicating placement of the one or more devices corresponding to the one or more device models in the physical environment modeled by the test environment.

22. The storage medium of claim 21, wherein values of modeled device data generated during the simulation are to be presented in the graphical representation.

23. A method comprising:
populating a test environment with one or more device models, wherein each device model simulates a respective device, the test environment simulates a physical environment, and the one or more device models are populated in the IoT testing environment to model a deployment of devices corresponding to the device models in the physical environment;
generating, based on the one or more device models, modeled device data to simulate data generated by corresponding devices;
transmitting the modeled device data to an application;
receiving application data from the application based on the modeled device data; and
generating modeled responses, by at least some of the one or more device models, to the application data.

24. A system comprising:
a data processor device;
computer memory to store:
a plurality of device models, wherein each of the plurality of device models comprises logic to model behavior of a respective device; and
at least one Internet of Things (IoT) environment model to model a physical environment; and
an Internet of Things (IoT) testing system, executable by the data processor device to:
populate the IoT testing environment with a set of device models from the plurality of device models to model a deployment of devices corresponding to the IoT asset models in the physical environment;
generate, based on the one or more device models, modeled device data to simulate data generated by corresponding devices;
transmit the modeled device data to an application; and
receive particular application data from the application based on the modeled device data.

25. (canceled)
